(19) United States
(12) Patent Application Publication
(10) Pub. No.: US 2010/0109564 A1
(43) Pub. Date: May 6, 2010

(54) ADJUSTABLE COLOR ILLUMINATION SOURCE

(76) Inventors: Dong Soo Shin, ShangHai (CN); Jian Wang, ShangHai (CN)

Correspondence Address: FAY SHARPE LLP, 1228 Euclid Avenue, 5th Floor, The Halle Building, Cleveland, OH, 44115, US

(21) Appl. No.: 12/566,938

(22) Filed: Sep. 25, 2009

Related U.S. Application Data
(60) Provisional application No. 61/100,067, filed on Sep. 25, 2008.

(51) Int. Cl. H05B 37/02

(52) U.S. Cl. 315/294

(57) ABSTRACT

An adjustable adjustable color illumination source comprises: a first color channel including at least first and second sub-channels independently selectively switchable on or off to generate illumination of a first color with at least three different selectable intensity levels not including zero intensity; a second color channel including at least first and second sub-channels independently selectively switchable on or off to generate illumination of a second color with at least three different selectable intensity levels not including zero intensity; a third color channel including at least first and second sub-channels independently selectively switchable on or off to generate illumination of a third color with at least three different selectable intensity levels not including zero intensity; the first, second, and third color channels arranged such that the illumination of the first, second, and third colors combine to generate a source illumination; and a controller communicating with the first, second, and third color channels to selectively switch on or off the sub-channels of the first, second, and third color channels to adjust the source illumination to a selected one of at least sixty four different colors. light source comprises a light source having input channels for generating illumination of different channel colors, and an electrical power supply selectively energizing the input channels in a time division multiplexed fashion to generate a illumination of a selected color.

### BACKGROUND

The following relates to the illumination arts, lighting arts, and related arts.

In solid state lighting devices including a plurality of LEDs of different colors, control of both intensity and color is typically achieved using pulse width modulation (PWM). For example, Chliwnyj et al., U.S. Pat. No. 5,924,784 discloses independent microprocessor-based PWM control of two or more different light emitting diode sources of different colors to generate light simulating a flame. Such PWM control is well known, and indeed commercial PWM controllers have long been available specifically for driving LEDs. See, e.g., Motorola Semiconductor Technical Data Sheet for MC68HCO5D9 8-bit microcomputer with PWM outputs and LED drive (Motorola Ltd., 1990). In PWM, a train of pulses is applied at a fixed frequency, and the pulse width is modulated to control the time-integrated power applied to the light emitting diode. Accordingly, the time-integrated applied power is directly proportional to the pulse width, which can range between 0% duty cycle (no power applied) to 100% duty cycle (power applied for the entire time interval).

Existing PWM illumination control has certain disadvantages. For a typical red/green/blue type system. Full color PWM control entails providing three independent power supplies, one for each of the red, green, and blue channels, each of which must be a high-speed switching power supply capable of operating at switching speeds corresponding to the pulse frequency. The pulse frequency must be faster than the flicker fusion threshold, which the frequency above which flickering caused by the light color switching becomes substantially visually imperceptible. This frequency is preferably of order about 30 Hz or higher. The power supply for each color channel must also include high-precision control of the pulse width. These complex characteristics of PWM controllers increase manufacturing cost.

The fundamental or harmonic frequency components entailed in performing PWM control also have the potential to generate radio frequency interference (RFI), which can be problematic in residential and commercial environments.

Another concern with PWM illumination control is that the pulsating operation of the LEDs may have the potential to shorten LED operational lifetime.

PWM has become a common approach for adjustable color control of illumination sources including red, green, and blue channels (or other sets of channels providing time-averaged illumination of a selected color or other characteristics). However, other approaches have also been used, typically employing variant pulse modulation schemes. For example, in pulse frequency modulation, pulses of a fixed width are used, with the frequency of pulse repetition varied to achieve adjustable color control. These variant pulse modulation schemes typically exhibit some of the disadvantages of PWM, such as complex and costly high speed switchable power supplies, possible RFI generation, and possibly adverse impact of continuous high-speed switching on LED operational lifetime.

### BRIEF SUMMARY

The illustrative claims appended at the end provide a non-exhaustive summary of some disclosed embodiments.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically illustrates an illumination system.

FIG. 2 diagrammatically shows a look-up table for determining switch settings for different colors at a selected constant intensity level.

FIG. 3 diagrammatically illustrates the red power supply of FIG. 1.

### DETAILED DESCRIPTION OF PREFERRED EMBODIMENTS

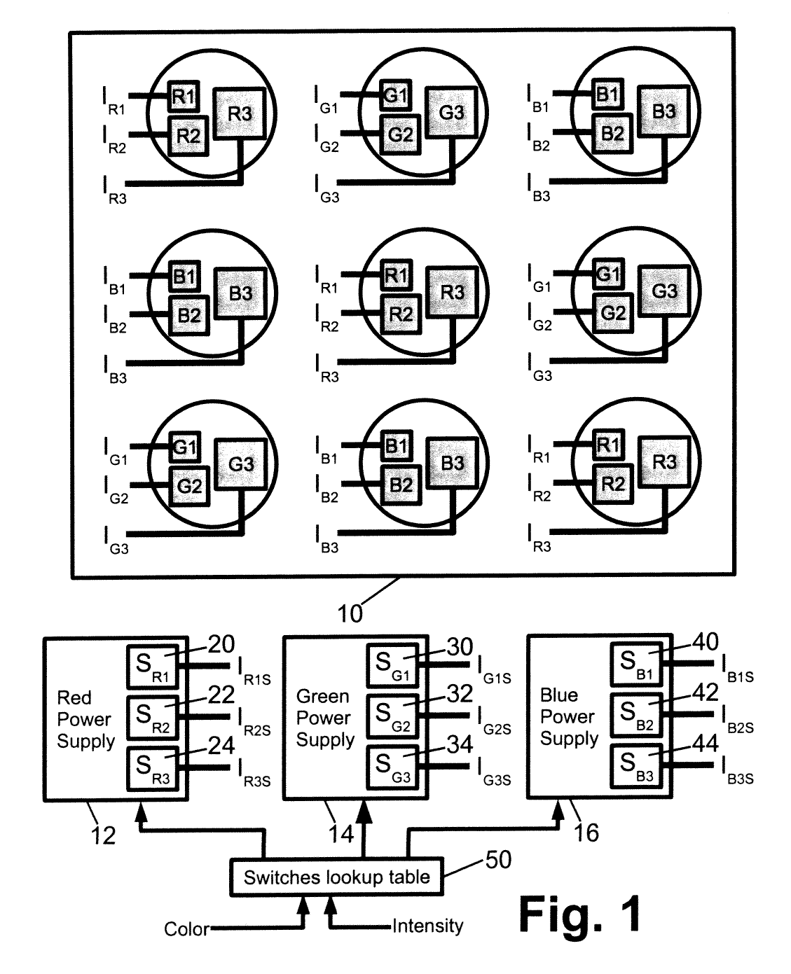

With reference to FIG. 1, a solid state lighting system includes an illumination source 10 having a plurality of red, green, and blue light emitting diodes (LEDs). The red LEDs include small red LEDs 141, medium sized red LEDs R2, and large red LEDs R3. The green LEDs include small green LEDs G1, medium sized green LEDs G2, and large green LEDs G3. The blue LEDs include small blue LEDs B1, medium sized blue LEDs B2, and large blue LEDs B3. In some instances, the plural sets of red LEDs are referred to as a red channel, and each set of small, medium, and large red LEDs R1, R2, R3 is referred to as a sub-channel of the red channel, with analogous phraseology for green and blue channels and sub-channels.

The various types of LEDs R1, R2, R3, G1, G2, G3, B1, B2, B3 across a light-emitting surface or area 10. In the illustrated embodiment, the red LEDs are grouped into LED groups each including one small red LED R1, one medium red LED R2, and one large red LED R3. Similarly, the green LEDs are grouped into LED groups each including one small green LED G1, one medium green LED G2, and one large green LED G3; and the blue LEDs are grouped into LED groups each including one small blue LED B1, one medium blue LED B2, and one large blue LED B3. However, this arrangement is optional, and other arrangements can be used for distributing the various types of LEDs R1, R2, R3, G1, G2, G3, B1, B2, B3 across the light-emitting surface or area 10.

The small red LEDs R1 are electrically interconnected (circuitry not shown) such that a drive electrical current I_{R1} can be flowed through the small red LEDs R1. In one approach, all small red LEDs R1 are suitably connected in electrical series such that the drive electrical current I_{R1} can be flowed through the series. In another approach, sub-groups of N small red LEDs can be connected in parallel and the sub-groups connected in series such that an input drive current of magnitude N times I_{R1} input to the series causes the current I_{R1} to flow through the individual small red LEDs R1. This latter arrangement, referred to herein as a series-parallel arrangement with a parallel factor N, enhances robustness against an open-circuit or other high-resistance failure of one of the small red LEDs.

In analogous fashion, the medium red LEDs R2 are electrically interconnected such that a drive electrical current I_{R2} can be flowed through the medium red LEDs R2. The large red LEDs R3 are electrically interconnected such that a drive electrical current I_{R3} can be flowed through the large red LEDs R2. The small green LEDs G1 are electrically interconnected such that a drive electrical current I_{G1} can be flowed through the small green LEDs G1. The medium green LEDs G2 are electrically interconnected such that a drive electrical current I_{G2} can be flowed through the medium green LEDs G2. The large green LEDs G3 are electrically interconnected such that a drive electrical current I_{G3} can be flowed through the large green LEDs G3. The small blue LEDs B1 are electrically interconnected such that a drive electrical current I_{B1} can be flowed through the small blue LEDs B1. The medium blue LEDs B2 are electrically interconnected such that a drive electrical current I_{B2} can be flowed through the medium blue LEDs B2. The large blue LEDs B3 are electrically interconnected such that a drive electrical current I_{B3} can be flowed through the large blue LEDs B3.

An adjustable color controller includes red, green, and blue power supplies 12, 14, 16. The red power supply 12 includes a small red LED driver switch 20 that switches on or off a constant root mean square (rms) current I_{R1S} that is input to the small red LEDs R1. If the small red LEDs R1 are interconnected in series, then the constant rms current I_{R1S} is suitably equal to the drive electrical current I_{R1} to be flowed through the small red LEDs R1. On the other hand, if the small red LEDs R1 are interconnected in a series-parallel configuration with parallel factor N, then the constant rms current I_{R1S} is suitably equal to N times the drive electrical current I_{R1} to be flowed through the small red LEDs R1, that is, I_{R1S}=N×I_{R1}.

Thus, when the small red LED driver switch 20 is off, there is no drive current flowing through the small red LEDs R1 and they do not emit light. When the small red LED driver switch 20 is on, the drive current I_{R1} flows through the small red LEDs R1 and they do emit light.

In similar fashion, the red power supply 12 includes a medium red LED driver switch 22 that switches on or off a constant rms current I_{R2S} that is input to the medium red LEDs R2. For a purely serial interconnection of the medium red LEDs R2, I_{R2S}=I_{R2}; whereas, for a series-parallel interconnection of parallel factor N the current I_{R2S}=N×I_{R2}. Again, by switching the medium red LED driver switch 22 the medium red LEDs R2 can be turned on or off Still further, the red power supply 12 includes a large red LED driver switch 24 that switches on or off a constant rms current I_{R3S} that is input to the large red LEDs R3. For a purely serial interconnection of the large red LEDs R3, I_{R3S}=I_{R3}; whereas, for a series-parallel interconnection of parallel factor N the current I_{R3S}=N×I_{R3}. Again, by switching the large red LED driver switch 24 the large red LEDs R3 can be turned on or off

The green power supply 14 includes a small green LED driver switch 30 that switches on or off a constant rms current I_{G1S} that is input to the small green LEDs G1. If the small green LEDs G1 are interconnected in series, then the constant rms current I_{G1S} is suitably equal to the drive electrical current I_{G1} to be flowed through the small green LEDs G1. On the other hand, if the small green LEDs G1 are interconnected in a series-parallel configuration with parallel factor N, then the constant rms current I_{G1S} is suitably equal to N times the drive electrical current I_{G1} to be flowed through the small green LEDs G1, that is, I_{G1S}=N×I_{G1}. The green power supply 14 also includes a medium green LED driver switch 32 that switches on or off a constant rms current I_{G2S} that is input to the medium green LEDs G2. If the medium green LEDs G2 are interconnected in series, then the constant rms current I_{G2S} is suitably equal to the drive electrical current I_{G2} to be flowed through the medium green LEDs G2. On the other hand, if the medium green LEDs G2 are interconnected in a series-parallel configuration with parallel factor N, then the constant rms current I_{G2S} is suitably equal to N times the drive electrical current I_{G2} to be flowed through the medium green LEDs G2, that is, I_{G2S}=N×I_{G2}. The green power supply 14 also includes a large green LED driver switch 34 that switches on or off a constant rms current I_{G3S} that is input to the large green LEDs G3. If the large green LEDs G3 are interconnected in series, then the constant rms current I_{G3S} is suitably equal to the drive electrical current I_{G3} to be flowed through the large green LEDs G3. On the other hand, if the large green LEDs G3 are interconnected in a series-parallel configuration with parallel factor N, then the constant rms current I_{G3S} is suitably equal to N times the drive electrical current I_{G3} to be flowed through the large green LEDs G3, that is, I_{G3S}=N×I_{G3}.

The blue power supply 16 includes a small blue LED driver switch 40 that switches on or off a constant rms current I_{B1S} that is input to the small blue LEDs B1. If the small blue LEDs B1 are interconnected in series, then the constant rms current I_{B1S} is suitably equal to the drive electrical current I_{B1} to be flowed through the small blue LEDs B1. On the other hand, if the small blue LEDs B1 are interconnected in a series-parallel configuration with parallel factor N, then the constant rms current I_{B1S} is suitably equal to N times the drive electrical current I_{B1} to be flowed through the small blue LEDs B1, that is, I_{B1S}=N×I_{B1}. The blue power supply 14 also includes a medium blue LED driver switch 42 that switches on or off a constant Has current I_{B2S} that is input to the medium blue LEDs B2. If the medium blue LEDs B2 are interconnected in series, then the constant rms current I_{B2S} is suitably equal to the drive electrical current I_{B2} to be flowed through the medium blue LEDs B2. On the other hand, if the medium blue LEDs B2 are interconnected in a series-parallel configuration with parallel factor N, then the constant rms current I_{B2S} is suitably equal to N times the drive electrical current I_{B2} to be flowed through the medium blue LEDs B2, that is, I_{B2S}=N×I_{B2}. The blue power supply 14 also includes a large blue LED driver switch 44 that switches on or off a constant rms current I_{B3S} that is input to the large blue LEDs B3. If the large blue LEDs B3 are interconnected in series, then the constant rms current I_{B3S} is suitably equal to the drive electrical current I_{B3} to be flowed through the large blue LEDs B3. On the other hand, if the large blue LEDs B3 are interconnected in a series-parallel configuration with parallel factor N, then the constant rms current I_{B3S} is suitably equal to N times the drive electrical current I_{B3} to be flowed through the large blue LEDs B3, that is, I_{B3S}=N×I_{B3}.

To understand how the system of FIG. 1 provides versatile adjustable color control without the complexity of pulse modulation and the corresponding potential for RFI, consider a system in which the red LED currents I_{R1}, I_{R2}, I_{R3} applied to the respective sets of small, medium, and large red LEDs R1, R2, R3 provide red light of three corresponding respective optical power levels P1, 2×P1, and 4×P1; and where similarly the green LED currents I_{G1}, I_{G2}, I_{G3} applied to the respective sets of small, medium, and large green LEDs G1, G2, G3 provide green light of the three corresponding respective optical power levels P1, 2×P1, and 4×P1; and where the blue LED currents I_{B1}, I_{B2}, I_{B3} applied to the respective sets of small, medium, and large blue LEDs B1, B2, B3 provide blue light of the three corresponding respective optical power levels P1, 2×P1, and 4×P1. Table 1 shows the power levels attainable for a given color channel (for example, either the red channel, or the green channel, or the blue channel) by illuminating various combinations of the small, medium, and large sets of LEDs of the given color channel. For three color channels, this corresponds to eight possible levels (including zero power, i.e. off; corresponds to seven possible levels without counting zero power).

TABLE 1

| | Set of medium | Set of large | Total |
|---|---|---|---|
| Set of small LEDs | LEDs | LEDs | Power |
| Off | Off | Off | 0 |
| On (power = P) | Off | Off | P |
| Off | On (power = 2 × P) | Off | 2P |
| On (power = P) | On (power = 2 × P) | Off | 3P |
| Off | Off | On (power = 4 × P) | 4P |
| On (power = P) | Off | On (power = 4 × P) | 5P |
| Off | On (power = 2 × P) | On (power = 4 × P) | 6P |
| On (power = P) | On (power = 2 × P) | On (power = 4 × P) | 7P |

For three color channels, this provides 8×8×8=512 possible combinations of color and intensity. Each combination has (i) an illumination color defined by the relative intensity ratios of the three channels and (ii) an illumination intensity defined by the sum of the intensities of the three channels. For example, the total visually perceived optical power can be represented as:

Pₜₒₜₐₗ=A_{R}P_{R}+A_{G}P_{G}+A_{B}P_{B} (1),

where P_{R}, P_{G}, and P_{R} are the optical power output by the red, green, and blue channels and the constants A_{R}, A_{G}, and A_{B} adjust for relative visual sensitivity differences between the red, green, and blue colors. The color can be represented as:

$$( {u}_{R} , {v}_{G} , {w}_{B} ) = ( \frac{{A}_{R} {P}_{R}}{{P}_{total}} , \frac{{A}_{G} {P}_{G}}{{P}_{total}} , \frac{{A}_{B} {P}_{B}}{{P}_{total}} ) , \qquad ( 2 )$$

where each of the coordinates u_{R}, v_{G}, and w_{B} lie in the range [0,1]. The color representation of Equation (2) can readily be converted to other color coordinate systems using known conversion formulae. The combinations do not provide every achievable color at every achievable intensity, or vice versa. The most color/intensity flexibility is achieved for intermediate intensity levels. For example, assuming A_{R}=A_{G}=A_{B}=1 and each channel power being selectable as per Table 1, there are between 46 and 48 different attainable colors for each of the intermediate intensities Pₜₒₜₐₗ=9P, Pₜₒₜₐₗ=10P, Pₜₒₜₐₗ=11P, and Pₜₒₜₐₗ=12P. On the other hand, there is only one attainable color for the maximum power level of Pₜₒₜₐₗ=21P, namely the color (⅓,⅓,⅓); and only three attainable colors for the minimum (non-zero) total power level of Pₜₒₜₐₗ=P, namely (1,0,0), (0,1,0), and (0,0,1). The available 46-48 colors for power levels in the intermediate range is sufficient for typical adjustable color illumination applications. For example, 46 available colors provides sufficient color resolution to perform smooth transitions from one color to another at a constant intensity level. It is also contemplated to further add a fourth, fifth or more sub-channels to each color channel provide larger numbers of color and intensity combinations. Going the other direction, it is contemplated to include only two different sub-channels of LEDs of a given color, which can provide up to 4 power levels (including zero power; three power levels not including zero power), and if this is done for all three color channels the adjustable color illumination source can provide 4³=64 combinations of color and intensity.

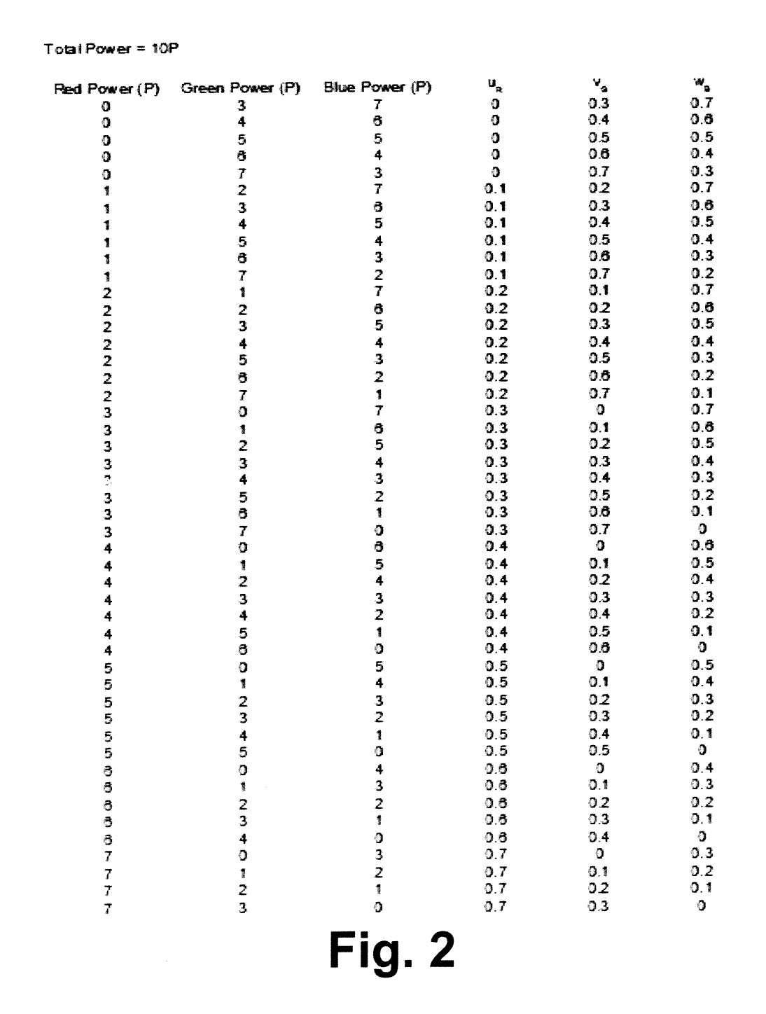

With reference to FIGS. 1 and 2, color control is suitably implemented using a lookup table 50 relating the switches 20, 22, 24, 30, 32, 34, 40, 42, 44 or equivalent information to the desired color and intensity. For example FIG. 2 shows a lookup table for various colors represented using the (u_{R},v_{G},w_{B}) representation of Equation (2), assuming A_{R}=A_{G}=A_{B}=1 and each channel power being selectable as per Table 1, for an intensity level total power Pₜₒₜₐₗ=10P. The saturation colors of pure red, pure green, or pure blue colors are not attainable for this power level. More saturated colors than those shown in FIG. 2 are attainable at the cost of a slight change in total power (completely saturated colors are attainable at Pₜₒₜₐₗ=7P or lower, for example). A high level of color flexibility is obtained at intermediate intensity levels for colors near white. Thus, a constant intensity adjustable color illumination source intended to output white light of various characteristics (e.g., cold white or warm white) is readily implemented.

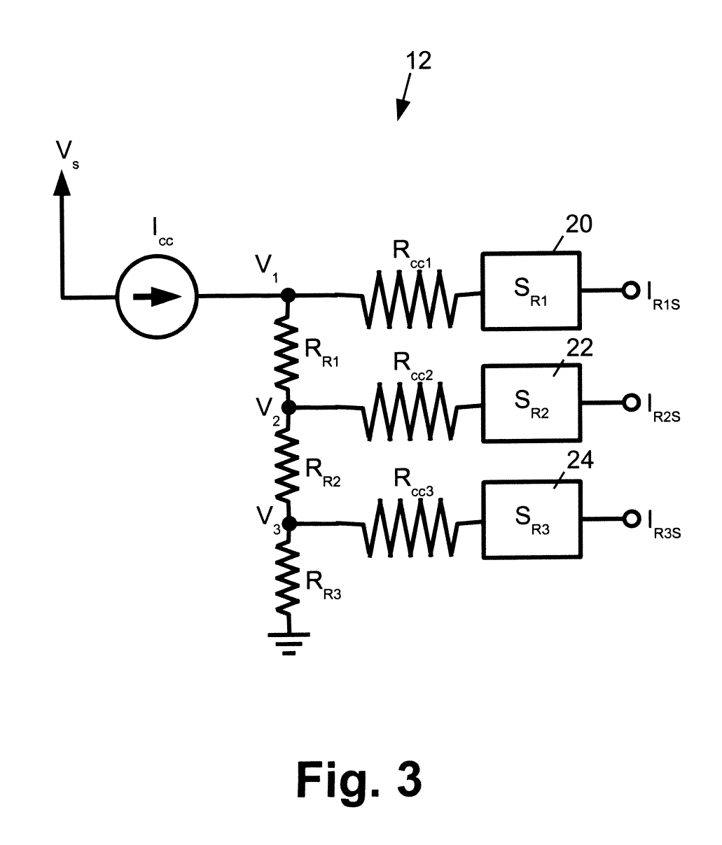

With reference to FIG. 3, the simplicity of the power supplies 12, 14, 16 is illustrated by depicting an electrical schematic for one suitable embodiment of the red power supply 12. (The green and blue power supplies 14, 16 can be analogously constructed). The illustrated red power supply 12 employs a constant current source I_{cc} powering a simple voltage divider formed by resistors R₁, R₂, and R₃. In the described operation, each of the resistors R₁, R₂, and R₃ is assumed to have a much lower resistance value than output resistors R_{cc1}, R_{cc2}, and R_{cc3}, and the output resistors R_{cc1}, R_{cc2}, and R_{cc3} are assumed to have much larger impedance than the driven set of LEDs. Under these assumptions, voltages V₁, V₂, and V₃ are given by:

V₁=I_{cc}·(R₁+R₂+R₃) (3),

V₂=I_{cc}·(R₂+R₃) (4),

and

V₃=I_{cc}·R₃ (5),

and the currents I_{R1S}, I_{R2S}, and I_{R3S} each have substantially constant rms value given by:

$$\begin{matrix}{I}_{R 1 S} = \frac{{V}_{1}}{{R}_{cc 1}} = \frac{{I}_{cc}}{{R}_{cc 1}} \cdot ( {R}_{1} + {R}_{2} + {R}_{3} ) , & ( 6 ) \\ {I}_{R 2 S} = \frac{{V}_{2}}{{R}_{cc 2}} = \frac{{I}_{cc}}{{R}_{cc 2}} \cdot ( {R}_{2} + {R}_{3} ) , \\ and & ( 7 ) \\ {I}_{R 1 S} = \frac{{V}_{3}}{{R}_{cc 3}} = \frac{{I}_{cc}}{{R}_{cc 3}} \cdot {R}_{3} . & ( 8 )\end{matrix}$$

If the output resistors R_{cc1}, R_{cc2}, and R_{cc3} are variable resistors, then the magnitudes of the currents I_{R1S}, I_{R2S}, and I_{R3S} can also be adjusted in a continuous fashion in accordance with Equations (6)-(8). For example, such adjustment can be used in the previous example to achieve more saturated colors at total power Pₜₒₜₐₗ=10P.

The power supply circuit of FIG. 3 is an illustrative example. Other circuits can be used to generate the constant rms currents I_{R1S}, I_{R1S}, and I_{R3S}, such as transistor-based power supply circuits, switching power supplies, and so forth. In the case of a switching power supply, the output currents I_{R1S}, I_{R2S}, and I_{R3S} can be d.c. or substantially d.c. (e.g., perhaps with some ripple) and the high frequency components of the power supply disposed in a shielded box so that RFI is minimized. Moreover, it is contemplated for the output currents I_{R1S}, I_{R2S}, and I_{R3S} to have a constant rms level but to be other than d.c. For example, the output currents I_{R1S}, I_{R1S}, and I_{R3S} can be sinusoidal a.c. currents of constant rms value. As already noted, “constant” rms level is to be broadly construed as allowing some adjustment of the current level, for example by trimming or adjusting the output resistors R_{cc1}, R_{cc2}, and R_{cc3}.

Heretofore, adjustable color operation of illumination sources including red, green, and blue channels has typically been performed using pulse modulation techniques such as PWM. The skilled artisan may find it surprising that the approach described herein can provide practical adjustable color operation, even up to and including full color operation with white light as an available output, without the concomitant complexity, RFI concerns, and other disadvantages entailed in pulse modulation control techniques.

One factor enabling the presently disclosed approach is the recognition that an adjustable color illumination source typically does not require the high color resolution that is typically desired for a full-color display. It is further recognized herein that an adjustable color illumination source also does not typically require complete independence of intensity and color. For example, the inability to achieve all color combinations at precisely Pₜₒₜₐₗ=10P (see FIG. 2) is not problematic for an adjustable color illumination source.

Heretofore, designers of adjustable color illumination sources have typically constructed illumination systems using substantially the same PWM control as is typically used in full color LED displays. It is recognized herein that an adjustable color illumination device is very different from a full-color display, and accordingly color and intensity control techniques appropriate for a full-color display may be less than optimal for controlling an adjustable color illumination device. By taking a fundamentally different approach that recognizes the less stringent requirements for a typical adjustable color illumination device, substantially less complex and yet operatively satisfactory devices are contemplated and disclosed herein.

The illumination device or source 10 is an illustrative example; in general the illumination source can be any multi-color illumination source having sets of solid state light sources electrically interconnected to define different color channels. In some embodiments, for example, the red, green, and blue LEDs are arranged as red, green, and blue LED strings. Moreover, the different colors can be other than red, green, and blue, and there can be more or fewer than three different color channels. For example, in some embodiments a blue channel and a yellow channel are provided, which enables generation of various different colors that span a color range less than that of a full-color RGB light source, but including a “whitish” color achievable by suitable blending of the blue and yellow channels. The individual LEDs are diagrammatically shown as black, gray, and white dots in the light source 10 of FIG. 1. The LEDs can be semiconductor-based LEDs (optionally including integral phosphor), organic LEDs (sometimes represented in the art by the acronym OLED), semiconductor laser diodes, or so forth. The different sets of LEDs of a given color do not need to have different sizes or different power outputs. For example, the red LED sets can all have the same size and power output, optionally even using the same type of LED chips for each red LED set. As already mentioned, the illustrative example of three sets of LEDs per color channel can be replaced by two, four, or more sets per color channel. Moreover, different color channels can have different numbers of sets of LEDs. Still further, the device need not be a full color device including three primary colors. For example, an adjustable color device intended to achieve white light of adjustable color characteristics (e.g., adjustable color temperature providing varying degrees of warm or cold white, adjustable color rendering, or so forth) may use color channels other than red, green, and blue. For example, red, green, amber, and blue color channels may be provided, with the blue color channel having a substantially lower maximum optical output compared with other color channels. Still further, although series and series-parallel interconnections are described for the sets of LED chips, other interconnection topologies are also contemplated. Likewise, the illustrated switches switches 20, 22, 24, 30, 32, 34, 40, 42, 44 or are incorporated with the power supplies 12, 14, 16, but in other contemplated embodiments the switches may form a separate control unit or be otherwise arranged respective to the power supplies and the illumination device.

Appended claims follow. These appended claims are representative, and it is to be understood that the invention further encompasses other novel and nonobvious aspects not expressly set forth in these claims.

1. An adjustable color illumination source comprising:
a plurality of sets of LED chips of a first color;
at least one additional plurality of LED chips of at least one additional color;
a power supply having a plurality of constant rms current outputs corresponding to the sets of LED chips of the first and at least one additional colors, the constant rms current outputs operatively connected with the corresponding sets of LED chips of the first and at least one additional colors; and
a controller configured to selectively turn on or off selected constant i rms current outputs of the power supply to generate illumination of a selected color.

2. The adjustable color illumination source of claim 1, wherein the controller is further configured to adjust magnitudes of the constant rms current outputs of the power supply.

3. The adjustable color illumination source of claim 1, wherein the rms current outputs operatively connected with the sets of LED chips of the first color include rms current outputs of different magnitude.

4. The adjustable color illumination source of claim 3, wherein the plurality of sets of LED chips of the first color include a first at least one LED chip of the first color of a first size and a second at least one LED chip of the first color of a second size larger than the first size, wherein the rms current output operatively connected with the at least one first LED chip of the first color has a smaller rms current magnitude than the rms current output operatively connected with the second at least one LED chip of the first color.

5. The adjustable color illumination source of claim 1, wherein the plurality of constant rms current outputs of the power supply are constant d.c. current outputs.

6. The adjustable color illumination source of claim 1, wherein:
the plurality of sets of LED chips of the first color include at least three sets of LED chips of the first color and (i) the controller by selectively turning on or off selected constant rms current outputs operatively connected with the at least three sets of LED chips of the first color can selectively generate at least seven different optical power levels of the first color.

7. The adjustable color illumination source of claim 6, wherein the at least one additional plurality of LED chips of at least one additional color include a plurality of sets of LED chips of a second color and a plurality of sets of LED chips of a third color, wherein:
(i) the plurality of sets of LED chips of the second color include at least three sets of LED chips of the second color and (ii) the controller by selectively turning on or off selected constant rms current outputs operatively connected with the at least three sets of LED chips of the second color can selectively generate at least seven different optical power levels of the second color; and
(i) the plurality of sets of LED chips of the third color include at least three sets of LED chips of the third color and (ii) the controller by selectively turning on or off selected constant rms current outputs operatively connected with the at least three sets of LED chips of the third color can selectively generate at least seven different optical power levels of the third color.

8. The adjustable color illumination source of claim 1, wherein the at least one additional plurality of LED chips of at least one additional color include a plurality of sets of LED chips of a second color and a plurality of sets of LED chips of a third color, wherein:
(i) the plurality of sets of LED chips of the first color include at least two sets of LED chips of the first color and (ii) the controller by selectively turning on or off selected constant rms current outputs operatively connected with the at least two sets of LED chips of the first color can selectively generate at least three different optical power levels of the first color not including zero power;
(i) the plurality of sets of LED chips of the second color include at least two sets of LED chips of the second color and (ii) the controller by selectively turning on or off selected constant rms current outputs operatively connected with the at least two sets of LED chips of the second color can selectively generate at least three different optical power levels of the second color not including zero power; and
(i) the plurality of sets of LED chips of the third color include at least two sets of LED chips of the third color and (ii) the controller by selectively turning on or off selected constant rms current outputs operatively connected with the at least two sets of LED chips of the third color can selectively generate at least three different optical power levels of the third color not including zero power;
whereby the adjustable color illumination source can selectively generate any one of at least sixty-four different combinations of color and intensity.

9. The adjustable color illumination source of claim 1, wherein the at least one additional plurality of LED chips of at least one additional color include a plurality of sets of LED chips of a second color and a plurality of sets of LED chips of a third color.

10. The adjustable color illumination source of claim 9, wherein:
the first, second, and third colors are three primary colors combinable to generate the illumination of the selected color as white light.

11. The adjustable color illumination source as set forth in claim 1, wherein the controller does not employ pulse modulation to generate illumination of the selected color.

12. The adjustable color illumination source as set forth in claim 1, wherein the controller does not employ pulse width modulation or pulse frequency modulation to generate illumination of the selected color.

13. An adjustable color illumination source comprising:
a first color channel including at least first and second sub-channels independently selectively switchable on or off to generate illumination of a first color with at least three different selectable intensity levels not including zero intensity;
a second color channel including at least first and second sub-channels independently selectively switchable on or off to generate illumination of a second color with at least three different selectable intensity levels not including zero intensity;
a third color channel including at least first and second sub-channels independently selectively switchable on or off to generate illumination of a third color with at least three different selectable intensity levels not including zero intensity;
the first, second, and third color channels arranged such that the illumination of the first, second, and third colors combine to generate a source illumination; and
a controller communicating with the first, second, and third color channels to selectively switch on or off the sub-channels of the first, second, and third color channels to adjust the source illumination to a selected one of at least sixty-four different combinations of color and intensity.

14. An adjustable color illumination method comprising:
(i) operating a first sub-set of LED chips using a first one or more constant rms currents to generate a first selected color; and
(ii) operating a second sub-set of LED chips using a second one or more constant rms currents to generate a second selected color different from the first selected color, the operating (ii) being after the operating (i) in time.

15. The adjustable color illumination source as set forth in claim 13, wherein the controller does not employ pulse modulation to generate illumination of the selected color.

16. The adjustable color illumination source as set forth in claim 13, wherein the controller does not employ pulse width modulation or pulse frequency modulation to generate illumination of the selected color.
